(19) United States
(12) Patent Application Publication
(10) Pub. No.: US 2007/0245120 A1
(43) Pub. Date: Oct. 18, 2007

(54) Multiple microcontroller system, instruction, and instruction execution method for the same

(76) Inventors: Jung Lin Chang, Hsin-Chu (TW); Chuan Po Ling, Hsin-Chu (TW); Shih-Yu Lin, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/403,857

(22) Filed: Apr. 14, 2006

(51) Int. Cl. G06F 15/00

(52) U.S. Cl. 712/10

(57) ABSTRACT

In a multiple microcontroller system comprising multiple MCU core logics, a multiple-MCU-core-logic selection operand is provided in an instruction according to this invention. The multiple-MCU-core-logic selection operand specifies or selects a corresponding MCU core logic in the system, and also specifies or selects a sub-unit of the MCU core logic, when necessary. Any MCU core logic in the system may be used as a main operation microcontroller unit to fetch and decode this instruction. An operation action corresponding to an operation code in the instruction is performed on the selected MCU core logic corresponding to the multiple-MCU-core-logic selection operand. The multiple microcontroller system can therefore directly specify an MCU core logic, and its sub-unit if necessary, on which a desired action is to be performed. Moreover, different MCUs in the multiple microcontroller system can share resources and control one another. True parallel processing is thus achieved.

### BACKGROUND OF THE INVENTION

1. Field of the Invention

The present invention relates to an instruction of a microcontroller system and an execution method for the same and, more particularly, to an instruction of a multiple microcontroller system and an execution method for the same.

2. Description of Related Art

With the progress of science and technology, computers have become more powerful than ever. A computer includes a CPU analogous to the heart of the computer, which controls peripheral hardware devices through computer programs analogous to the ideas and logics of the computer, to solve problems for a user as well as to finish tasks assigned by the user.

A computer program by which a computer executes a series of processing procedures is a combination of instructions and statements. A machine code is the most basic form of an instruction, which is composed of an operation code and an operand (or operands). The operand(s) in a machine code performs an action according to the operation code in the machine code. In order to simplify writing of a program, instructions and statements are written in the form of mnemonics. More specifically, an operand may be an address or a pure data, and an operation code defines the action of the operands such as data transfer, arithmetic operation, logic operation, bit operation, or program branching. Eq. (1) shows a conventional instruction including an operation code and two operands:
MOVA,REGA (1)
where MOV is an operation code representing data transfer, and A and REGA are operands representing an accumulator and a register A in a controller, respectively. Thus, the meaning of this instruction is to store the data in the register A into the accumulator in the controller.

Before the computer executes an instruction, a series of decoding and analysis tasks have to be done to interpret data and action represented by the operand(s) and the operation code, and thereafter assign a proper unit to execute them. Referring to FIG. 1(a) and FIG. 1(b), which are a block diagram of a conventional control system and a flowchart of an instruction execution method according to the conventional control system, respectively, the instruction in Eq. (1) will be explained below. As shown in FIGS. 1(a) and 1(b), a controller 16 first reads data in a memory 10 via a data bus 12 and temporarily stores it into an instruction register 14 (Step S01). The controller 16 then decodes the instruction in Eq. (1) to determine that the meaning of the instruction in Eq. (1) is to store the data in a register A 162 into an accumulator 161 in the controller 16 (Step S02). Next, according to the above interpretation, the controller 16 retrieves data in the register A 162 and store the data into the accumulator 161 (Step S03), completing the execution of the instruction in Eq. (1).

As readily seen from the above control system and its instruction execution method, the format of all instructions thereof are designed under the premise that the system has only a controller (or a main controller), and the fetch, decoding and execution of instructions are performed by this unique controller. In a multiple microcontroller system which has more than one microcontroller unit (MCU) core logics that can execute programs (and each MCU core logic may have corresponding registers or other associated circuit units), it is extremely difficult and complicated, if not impossible, to use the above instruction format to accomplish parallel and multi-task processing. In a multiple microcontroller system, it is very important for all MCUs to share internal resources, to be capable of reading a program execution status, and to be capable of controlling one another, in particular when the system is processing a complex program. With the above capabilities, the multiple microcontroller system may achieve true parallel processing and real-time response, and the system cost can be reduced.

The present invention therefore provides a multiple microcontroller system which employs an instruction with a format that can solve the above problems in the prior art, and also provides a method for executing the instruction, whereby parallel and multi-task processing is accomplished to effectively enhance the processing capability of the multiple microcontroller system.

### SUMMARY OF THE INVENTION

A primary object of the present invention is to provide an instruction for use in a multiple microcontroller system. The instruction comprises an operation code and at least a multiple-MCU-core-logic selection operand. When there are 2^{N} or less MCU core logics, at least N bits are required to select one from these MCU core logics, where these N bits can be consecutive or inconsecutive. The operation code defines the operation action of the instruction. The multiple-MCU-core-logic selection operand specifies (or, selects) a particular MCU core logic in the multiple microcontroller system; the multiple-MCU-core-logic selection operand may further contain a sub-operand to specify a sub-location. By such an instruction, an MCU core logic to be selected (and its sub-location defined by a sub-operand, if there is) in the multiple microcontroller system can be easily and exactly identified, and thus it is no more required to write any complicated program codes.

Another object of the present invention is to provide a multiple microcontroller system capable of performing operations according to the above instruction.

Yet another object of the present invention is to provide an instruction execution method of a multiple microcontroller system, in which a main MCU fetches and decodes an instruction, and by means of a multiple-MCU-core-logic selection operand in the instruction, a selected MCU core logic may cooperate with the main MCU to perform the action defined by the operation code; furthermore, data in a selected MCU core logic can be read out and directly written into a designated location of another selected MCU core logic. Through use of such an instruction and method, different MCU core logics in a multiple microcontroller system can share resources and control one another, thereby achieving true parallel and multi-task processing to enhance performance.

Still yet another object of the present invention is to provide a multiple microcontroller system capable of executing an instruction according to the above instruction execution method.

To achieve the above objects, the present invention provides an instruction for use in a multiple microcontroller system and an execution method for the same. The instruction for use in a multiple microcontroller system of the present invention comprises an operation code and at least a multiple-MCU-core-logic selection operand. The multiple-MCU-core-logic selection operand specifies or selects a particular MCU core logic in the multiple microcontroller system; the multiple-MCU-core-logic selection operand may further contain a sub-operand to specify a sub-location. An operation action corresponding to the operation code is performed on the selected MCU core logic. Moreover, the present invention also provides an execution method of this instruction in a multiple microcontroller system. After pre-determining a main operation MCU in the multiple microcontroller system (the main operation MCU may be any MCU or a dedicated MCU), an instruction is fetched and then decoded by the main operation MCU to acquire the information of an operation code and at least a multiple-MCU-core-logic selection operand in the instruction. An operation action defined by the operation code is carried out in at least an MCU specified by the multiple-MCU-core-logic selection operand.

According to the present invention, instructions can be written in a simple format so that different MCU core logics in the multiple microcontroller system can share resources and control one another. Any or a dedicated MCU core logic in the multiple microcontroller system can be selected as required to be the main operation MCU to fetch and decode the instructions. In the instructions, the multiple-MCU-core-logic selection operand selects an MCU core logic (and a sub-operand in the multiple-MCU-core-logic selection operand, if there is, selects its sub-location) as the object of an operation action, and the operation code defines the action; the multiple microcontroller system operates accordingly.

### BRIEF DESCRIPTION OF THE DRAWINGS

The various objects and advantages of the present invention will be more readily understood from the following detailed description when read in conjunction with the appended drawing, in which:

FIG. 1(a) is a block diagram of a conventional control system;

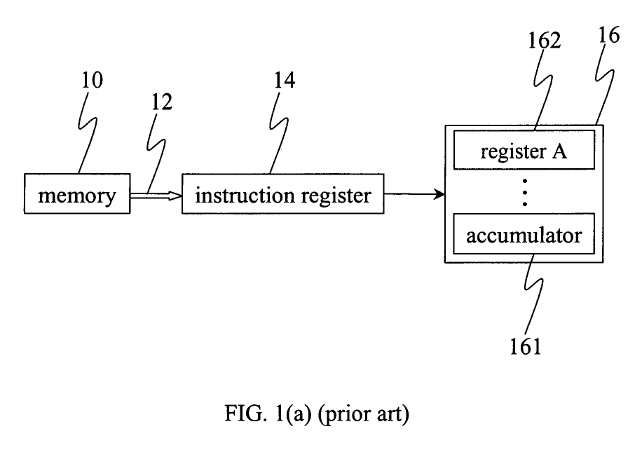

FIG. 1(b) is a flowchart of an instruction execution method of a conventional control system;

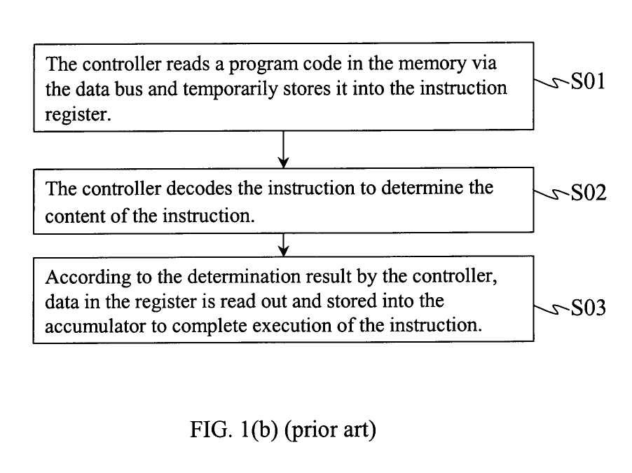

FIG. 2(a) is a block diagram of a control system according to an embodiment of the present invention; and

FIG. 2(b) is a flowchart of an instruction execution method according to an embodiment of the present invention.

### DETAILED DESCRIPTION OF THE PREFERRED EMBODIMENTS

A multiple microcontroller system according to this invention provides greatly enhanced processing capabilities of mutual access and control among multiple MCU core logics. One improvement of this invention as compared with conventional microcontroller systems is in that the instructions for use in the system employ an inventive format so that any MCU core logic can access data in any other MCU core logics in the multiple microcontroller system. The details are now described below.

In a multiple microcontroller system according to this invention, an instruction defining a task to be performed on an MCU core logic is composed of an operation code and at least a multiple-MCU-core-logic selection operand. The instruction may include any of the following combinations: an operation code and a multiple-MCU-core-logic selection operand; an operation code and two multiple-MCU-core-logic selection operands; an operation code, a multiple-MCU-core-logic selection operand, and another common operand (“common” meaning that the operand is not a multiple-MCU-core-logic selection operand); and so on. The content of the multiple-MCU-core-logic selection operand can be used to specify the information indicating one selected MCU core logic (and its sub-location, if necessary) among multiple MCU core logics, on which the operation action corresponding to the operation code is independently carried out. Or, the content of the multiple-MCU-core-logic selection operand can be used to specify the information indicating two selected MCU core logics (and their sub-locations if necessary), between which the operation action corresponding to the operation code is carried out cooperatively.

A first example according to the present invention includes one operation code and two multiple-MCU-core-logic selection operands, as shown in the following Eq. (2):
MOVM3A,M2REG2A (2)
where MOV is an operation code indicating “data transfer”, and M3A and M2REG2A are operands representing two different MCU core logics and their sub-location, respectively. The operand M3A includes two sectors: M3 and A, representing a third MCU core logic M3 and its internal sub-location A. The sub-location A corresponds to a third accumulator. This operand M3A for selection among multiple MCU core logics thus corresponds to the third accumulator of the third MCU core logic. The operand M2REG2A includes two sectors: M2 and REG2A, representing a second MCU core logic M2 and its internal sub-location REG2A. The sub-location REG2A corresponds to a register 2A. This operand M2REG2A for selection among multiple MCU core logics thus corresponds to the register 2A of the second MCU core logic. Therefore, the action defined by this instruction can be interpreted as: “transferring data from the register 2A of the second MCU core logic to the third accumulator of the third MCU core logic”.

The instruction described above is only one example of the present invention. In addition to the operation action of data transfer in Eq. (2), the same idea is applicable to other operation actions such as arithmetic operation, logic operation, bit operation and program branching. Any operation action to be executed in or by MCU core logics can be expressed in the instruction of the present invention.

In the case where there is one multiple-MCU-core-logic selection operand and one common operand, the common operand may be a source address, a destination address, or even a pure number data. For instance, the following Eq. (3) shows an instruction including an operation code and two operands:
MOVM1REG1B,#55H (3)
where MOV is still an operation code indicating “data transfer”, and M1REG1B and #55H are the multiple-MCU-core-logic selection operand and a common operand, respectively. Similar to the above instruction of Eq. (2), the operand M1REG1B for selection among multiple MCU core logics corresponds to the register 1B of the first MCU core logic. As for the operand #55H, it is a pure number data, indicating a constant “55H”. Therefore, the action defined by this instruction can be interpreted as: “transferring 55H into the register 1B of the first MCU core logic”.

The instruction of Eq. (2) is a combination of an operation code and two operands for selection among multiple MCU core logics, while the instruction of Eq. (3) is a combination of an operation code, a multiple-MCU-core-logic selection operand, and another common operand. Besides these two forms, it is of course possible for an instruction to include an operation code and only one multiple-MCU-core-logic selection operand, as shown in the following Eq. (4):
POPM3PC (4)
where POP is an operation code indicating “sending the content of the stack memory to a specified location”, and M3PC is the only operand (and is a multiple-MCU-core-logic selection operand) representing the program counter of the third MCU core logic. Therefore, the action defined by this instruction can be interpreted as: “sending the content of the stack memory into the program counter of the third MCU core logic”.

In the above Eqs. (2) to (4), each multiple-MCU-core-logic selection operand includes a sector representing the MCU core logic (M1, M2, M3 and so on) and a sub-operand representing the sub-location (A, REG2A, REG1B, PC and so on). But it is also possible that an instruction only defines an MCU core logic without defining its sub-location. In this case, the multiple-MCU-core-logic selection operand only includes a sector representing the MCU core logic but no sub-operand representing the sub-location. For example, if an instruction PUSHPC in the instruction set is defined as pushing the content of the program counter into the stack memory, the following Eq. (5) requires no sub-operand representing the sub-location:
PUSHPCM4 (5)
This instruction means pushing the content of the program counter of the fourth MCU core logic into the stack memory.

In the above description, the instructions are expressed by a higher level language. In fact, if translated to lower-level binary codes, the above Eqs. (2) to (5) will be represented by a series of binary digits, in which some digits represent the operation code and the other digits represent the operands. For instance, the above instructions may be represented each by a 16-bit binary code, with the five digits starting from the most significant bit (MSB) representing the operation code, and the other bits representing the operands.

In binary coding, each bit can be used for selection between two MCU core logics. Therefore, when there are 2^{N} or less MCU core logics, at least N bits are required for selection among these MCU core logics (in concept, the binary number composed of these N binary bits can be deemed as an identification (ID) of a corresponding MCU core logic). According to the present invention, these N bits can be consecutive (i.e., forming a number of N consecutive digits), or inconsecutive (i.e., scattered in a binary code representing an instruction). In most cases these N bits are included the operand, but they can be included in the operation code, or partially in the operand and partially in the operation code.

As a more specific example, if an instruction is represented by a 16-digit binary code and there are 24 operation codes to be defined in the instruction set, it requires five bits to identify an operation code, because 2⁴=16<24<32=2⁵. Therefore, the binary code of an instruction is arranged in a way that the five bits starting from the MSB are used to identify the operation code, and the other bits are used to identify the operands. Further, assuming that the multiple microcontroller system has eight MCU core logics (a 3-bit ID is thus required for identifying an MCU core logic), according to the present invention, the 3-bit ID of an MCU core logic may be arranged at, e.g., the 6th bit to 8th bit (consecutive), or the 14th bit to 16th bit (consecutive), or the 6th bit, 10th bit and 14th bit (inconsecutive). Moreover, because there are only 24 operation codes, 00000 to 10111 can be used to represent the first to the 23th operation codes, and 11xxx can be used to represent the 24th operation code. Following this arrangement, 11000 to 11111 can be used to represent the 24th operation of the first to eighth MCU core logics, respectively. In this case, the 3-bit ID for identifying an MCU core logic is included in the operand in the first to the 23th instructions, while the 3-bit ID for identifying an MCU core logic is included in the operation code in the 24th instruction.

In the above 24th instruction, although the MCU core logic ID is included in the operation code, in concept, we can still deem the operation code as the two bits starting from the MSB, and the multiple-MCU-core-logic selection operand as the bits starting from the 3rd bit.

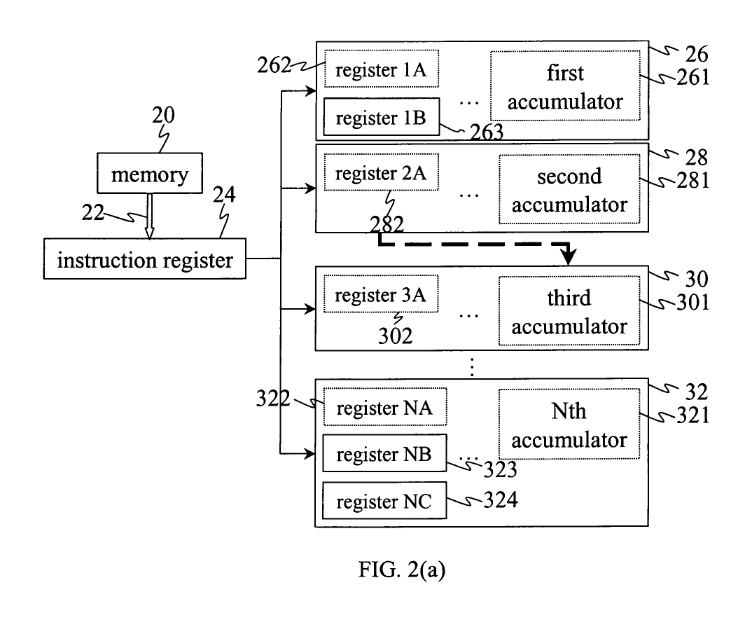

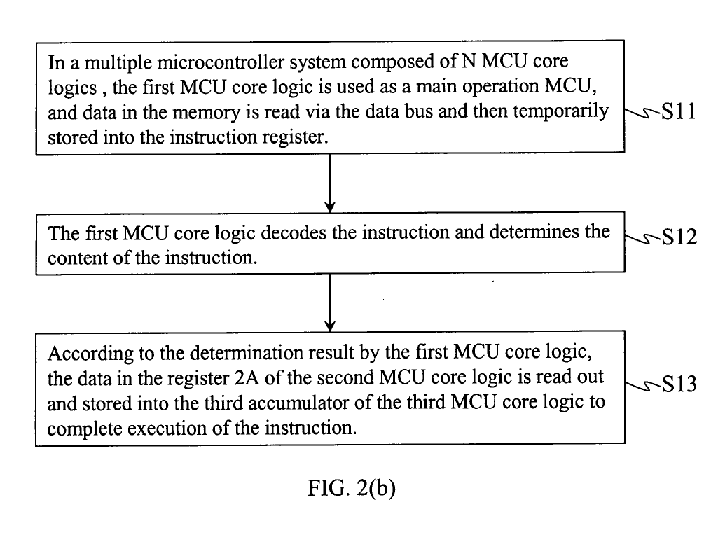

An instruction execution method according to a preferred embodiment of the present invention will be described below with reference to the instruction in Eq. (2) and FIGS. 2(a) and 2(b). FIG. 2(a) is a block diagram of a control system according to an embodiment of the present invention. FIG. 2(b) is a flowchart of an instruction execution method according to an embodiment of the present invention. As shown in FIG. 2(a), in a multiple microcontroller system composed of N MCU core logics 26, 28, 30, . . . and 32 having internal registers 262, 263, 282, 302, . . . and 322, 323, 324, respectively, the first MCU core logic 26 is used as a main operation MCU, and data in a memory 20 is read via a data bus 22 and then temporarily stored into an instruction register 24 (Step S11). The first MCU core logic 26 then decodes the instruction of Eq. (2) and determines that the content of the instruction indicates: “storing the data in the register 2A 282 of the second MCU core logic 28 into a third accumulator 301 of the third MCU core logic 30” (Step S12). Next, according to the above interpretation, the first MCU core logic 26 instructs the second MCU core logic 28 to read the data in the register 2A 282, and writes the data into the third accumulator 301 of the third MCU core logic 30 (the direction of data transfer shown as the thick dash line in FIG. 2(a)), thereby finishing execution of the instruction in Eq. (2) (Step S113).

Although the first MCU core logic is described as the main operation MCU in the above embodiment, according to the present invention, any MCU core logic can be selected to play the role of the main operation MCU, either randomly or by a predetermined rule, as required for different applications, so as to accomplish the optimum efficiency of the system.

Furthermore, although the ID number identifying an MCU core logic is directly designated in an instruction in the above embodiments, the same purpose may be achieved by an indirect, hidden manner. For example, the ID of a selected MCU core logic is first written into a register, and the content of this register is then called out by the next instruction. In this example, although the ID number identifying the MCU core logic does not appear in the latter instruction, it is actually equivalent to what is disclosed by this invention and thus should be embraced in the scope of the present invention.

As seen from the foregoing, the present invention provides a multiple microcontroller system, an instruction for use in the multiple microcontroller system, and an execution method for the same, so that each MCU in the system can directly communicate and cooperate with another MCU or any other internal/peripheral units by means of an easily-editable instruction, thereby making the multiple microcontroller system accomplish the optimum processing efficiency.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An instruction for use in a multiple microcontroller system, said multiple microcontroller system comprising a plurality of MCU core logics, said instruction comprising:
an operation code for defining an operation action of said instruction; and
at least a multiple-MCU-core-logic selection operand for selecting one of said MCU core logics on which said operation action defined by said operation code is carried out.

2. The instruction of a multiple microcontroller system as claimed in claim 1, wherein said instruction includes an MCU core logic ID expressed in the form of a binary code of N consecutive or inconsecutive bits, where N is a natural number.

3. The instruction of a multiple microcontroller system as claimed in claim 2, wherein said MCU core logic ID is arranged in one of the following ways consisting of: included in said operand; included in said operation code; and partially included in said operand and partially included in said operation code.

4. The instruction of a multiple microcontroller system as claimed in claim 1, wherein said instruction retrieves said MCU core logic ID from a location for storing said MCU core logic ID.

5. The instruction of a multiple microcontroller system as claimed in claim 1, wherein said multiple-MCU-core-logic selection operand comprises an ID of a MCU core logic and a sub-operand indicating a sub-unit associated said MCU core logic.

6. The instruction of a multiple microcontroller system as claimed in claim 1, wherein the selected MCU core logic can communicate with any other MCU core logic or any other peripheral unit via said instruction.

7. An instruction execution method of a multiple microcontroller system, said method comprising:
fetching an instruction by a main operation MCU core logic, said instruction including an operation code and at least a multiple-MCU-core-logic selection operand;
decoding said instruction; and
said main operation MCU core logic carrying out an operation action defined by said operation code on at least one MCU core logic selected by said multiple-MCU-core-logic selection operand.

8. The instruction execution method of a multiple microcontroller system as claimed in claim 7, wherein said multiple microcontroller system comprises a plurality of MCU core logics, and any one of said MCU core logics can play the role as said main operation MCU.

9. The instruction execution method of a multiple microcontroller system as claimed in claim 8, wherein said multiple-MCU-core-logic selection operand includes at least N consecutive or inconsecutive bits for selecting a corresponding MCU core logic among 2^{N} or less MCU core logics, where N is a natural number.

10. The instruction execution method of a multiple microcontroller system as claimed in claim 9, wherein said at least N bits are included arranged in one of the following ways consisting of: included in said operand; included in said operation code; and partially included in said operand and partially included in said operation code.

11. The instruction execution method of a multiple microcontroller system as claimed in claim 7, wherein in addition to identifying an MCU core logic, said multiple-MCU-core-logic selection operand also identifies a sub-unit associated with said MCU core logic.

12. The instruction execution method of a multiple microcontroller system as claimed in claim 1, wherein said identified MCU core logic can communicate with any other MCU core logic or any other peripheral unit via said instruction.

13. A multiple microcontroller system comprising a plurality of MCU core logics, each said MCU core logic having a corresponding MCU core logic ID expressed in the form of a binary code, wherein when said system executes an instruction related to one of said MCU core logics, said instruction includes said MCU core logic ID corresponding to said one MCU core logic.

14. The multiple microcontroller system as claimed in claim 13, wherein said instruction includes bits indicating an operation code and bits indicating an operand, and said MCU core logic ID is arranged in one of the following ways consisting of: included in said bits indicating said operand; included in said bits indicating said operation code; and partially included in said bits indicating said operand and partially included in said bits indicating said operation code.

15. A multiple microcontroller system comprising a plurality of MCU core logics, each said MCU core logic having a corresponding MCU core logic ID expressed in the form of a binary code, wherein when said system executes an instruction related to one of said MCU core logics, said instruction retrieves said MCU core logic ID corresponding to said one MCU core logic from a location for storing said MCU core logic ID.
